(19) United States
(12) Patent Application Publication
(10) Pub. No.: US 2006/0152770 A1
(43) Pub. Date: Jul. 13, 2006

(54) Gravure printing

(76) Inventor: Michael Keating, Chester (GB)

Correspondence Address: RICHARD I. SAMUEL;GOODWIN PROCTER L.L.P, 599 LEXINGTON AVE., NEW YORK, NY, 10022, US

(21) Appl. No.: 10/521,374

(22) PCT Filed: Feb. 20, 2003
(86) PCT No.: PCT/GB03/00744

§ 371 Date: Oct. 14, 2005

(30) Foreign Application Priority Data
Jul. 13, 2002 (GB) 0216303.8

(51) Int. Cl. B41C 1/04

(52) U.S. Cl. 358/3.29

(57) ABSTRACT

The invention relates to a method of engraving a plurality of gravure cells in a surface, the method comprising the steps of; (a) mounting an engraving stylus comprising a stylus body inwardly tapering to the stylus tip, in an engraving head; (b) effecting penetration of the engraving stylus into the surface to a desired depth to produce a cell; (c) effecting partial withdrawal of the engraving stylus from the cell; (d) effecting relative movement between the stylus and the surface such that the partially withdrawn stylus effects engraving of a channel of shallower depth than the cell in the surface and having a channel width of at least 40% of the width of the previous cell engraved in the method; and (e) effecting further penetration of the engraving stylus into the surface to a desired depth, and effecting relative movement between the stylus and surface to produce a cell. The invention further relates to novel gravure engraving styli, comprising triangular prism, triangular prismoid or planar quadrilateral shaped tips.

### FIELD OF THE INVENTION

This invention relates to methods of manufacturing gravure printing cylinders and to gravure printing styli.

### BACKGROUND TO THE INVENTION

Gravure printing is an intaglio process for long run high quality printing applications. The gravure printing process is a process whereby ink is transferred from small wells or cells that are engraved into the surface of a printing cylinder onto a suitable medium such as paper. The cylinder is engraved by one of three common processes:
(1) Chemical etching of the image;
(2) Laser engraving of the cells onto the surface of the cylinder; and
(3) Electro-mechanically engraving individual cells into the surface of the cylinder.

Once the cylinder has been engraved by either process, the cylinder is rotated through a fountain of ink, and excess ink removed by a doctor blade and returned to the ink fountain. An impression cylinder is used which is covered with a rubber composition that presses the printing paper, or other suitable material, into contact with the ink in the cells of the printing surface.

Gravure printing is capable of printing varying amounts and densities of ink to produce images that simulate continuous tone images. The cells that compose the images on the printing cylinder vary in volume corresponding to the tonal values in the images. In the case of laser gravure etching, it is capable of displaying etching speeds of up to 70,000 cells per second. However, laser etching involves the use of expensive laser equipment, which can be prohibitive in etching processes requiring only medium to high quality images, or in long run etching processes. Furthermore, many conventional printers have existing electro-mechanical engraving equipment, which would be costly to replace and upgrade to laser etching apparatus and processes.

Consequently, many gravure cylinders are made by electro-mechanical engraving systems which consist of three main parts. Firstly the system comprises an input unit which is generally a rotating drum on which a photographic printer is mounted in position and scanned by one or more reading heads. Secondly a computer processes the image densities recorded by the reading heads and converts them to electrical impulses that are transmitted to the third part of the system, an output unit consisting of a rotating copper plated cylinder on which are mounted one or more engraving heads with diamond styli that engrave the gravure cells in the copper cylinder corresponding to the strength of the electrical impulses from the computer.

Generally, the diamond stylus used in an electro-mechanical gravure engraving process is a diamond of triangular cross section, that engraves an inverted pyramid into the copper cylinder. This method produces a diamond or square shaped cell. A conventional gravure cell pattern is shown in FIG. 1. Each line of cells comprises a plurality of adjacent cells (10) separated by a narrow channel (12), with each cell (10) in a column being positioned corner to corner with adjacent cells (10). Horizontal lines across the copper cylinder comprise offset cells which produces zig zag channels between adjacent columns and rows of cells on the cylinder as shown in FIG. 1.

As can be seen from FIG. 1, a disadvantage in using a diamond stylus of triangular cross section is the formation of a jagged zig-zag edge at the outermost column and row of cells (10) of an image. These jagged edges detract from the overall image quality, and cause images to have a grainy or jagged appearance.

It is desirable in any printing process to attempt to recreate the original image as perfectly as possible, including, in the case of recreating photographic or line drawing images, the continuous smooth edges of each image within the photograph or drawing. The use of diamond styli of triangular cross section in traditional gravure processes prevents smooth edged peripheral lines in the etched gravurel cylinder, and hence a subsequent print image from the cylinder will also correspondingly have non smooth peripheral lines.

It is therefore an aim of the preferred embodiment of the present invention to overcome or mitigate at least one of the problems of the prior art, whether expressly disclosed here above or not.

### SUMMARY OF THE INVENTION

According to a first aspect of the present invention there is provided a method of engraving a plurality of gravure cells in a surface, the method comprising the steps of:
(a) mounting an engraving stylus comprising a stylus body inwardly tapering to the stylus tip, in an engraving head;
(b) effecting penetration of the engraving stylus into the surface to a desired depth to produce a cell;
(c) effecting partial withdrawal of the engraving stylus from the cell;
(d) effecting relative movement between the stylus and the surface such that the partially withdrawn stylus effects engraving of a channel of shallower depth than the cell in the surface and having a channel width of at least 40% of the width of the previous cell engraved in the method; and
(e) effecting further penetration of the engraving stylus into the surface to a desired depth, and effecting relative movement between the stylus and surface to produce a cell.

Preferably the method further comprises repeating steps (c) to (e) at least one more time, preferably a plurality of times.

Suitably step (c) comprises withdrawing the stylus from the cell such that the channel formed during step (d) has a width of substantially 45-65% of that of the previously engraved cell, preferably substantially 50%.

Thus when adjacent cells are the same depth and width are formed, having channels of substantially 45-65% width of the cells between each cell, the resultant line of cells have a substantially less jagged periphery than in conventional gravure printing where the channels are generally 15-20% of the width of adjacent cells. The depth of penetration of the stylus during step (e) may be different to the depth of penetration in step (b). Thus, adjacent cells may have differing depth and width.

Suitably, penetration of the stylus is effected to produce cells having a width of between substantially 50 μm to 80 μm.

Suitably penetration of the stylus is effected to produce cells having a depth of between substantially 20 μm to 35 μm.

Suitably the spacing formed by the channel between adjacent cells is between substantially 14 μm to 16 μm long.

According to a second aspect of the present invention there is provided a method of engraving a gravure cell in a surface the method comprising the steps of:
(a) mounting an engraving stylus in an engraving head;
(b) effecting penetration of the engraving stylus into the surface to a desired depth to produce a cell;
(c) passing direct current through the engraving head to effect continual penetration of the engraving stylus in the surface; and
(d) effecting relevant movement between the stylus and the surface such that the continued penetration of the stylus effects elongation of the engraved cell.

Suitably the stylus comprises a stylus body which tapers inwardly to the stylus tip and the method further comprises the steps of:
(e) effecting partial withdrawal of the engraving stylus from the cell;
(f) effecting relative movement between the stylus and the surface such that the partially withdrawn stylus effects engraving of a channel of shallower depth then the previous cell in the surface; and
(g) effecting further penetration of the engraving stylus into the surface to a desired depth, passing direct current through the engraving head and effecting further relative movement between the stylus and surface to produce a cell.

Suitably the method further comprises repeating steps (c) to (g) at least one more time, preferably a plurality of times.

Thus this method may be used to produce elongated cells having substantially smooth peripheral edges, so that a line of adjacent cells at the periphery of an image engraved on the surface has a relatively smooth peripheral edge compared to cells produced by conventional gravure printing which uses alternating current, which causes the engraving stylus to penetrate and withdraw from the surface quickly, and therefore forms non-elongated cells. The depth of penetration of the stylus during step (9) may be different to the depth of penetration in step (b). Thus, adjacent cells may have differing depths and widths.

Suitably the penetration of the stylus is effected to produce cells having a width of between substantially 50 μm to 80 μm.

Suitably penetration of the stylus is effected to produce cells having a depth of between substantially 30 μm to 100 μm.

Suitably the spacing formed by the channel between adjacent cells is between substantially 14 μm to 16 μm long. Thus the method of the second aspect of the invention relies on direct current engraving, allowing an engraving image to be cut without the engraving head oscillating in and out of the surface between two adjacent engraved cells/pixels. The result of this technique, especially with a quadrilateral-faced, planar-tipped stylus being used, gives an engraving image of increased volume compared to conventional engraving, but with straighter horizontal and vertical edges in the cell rows and columns. The use of direct current allows the engraving apparatus to be run without any alternating current.

The method may further comprise effecting complete withdrawal of the engraving head from the surface after a desired number of cells have been engraved, and subsequently effecting relative movement between the stylus and the surface, before effecting further penetration of the engraving stylus into the surface to a desired depth to produce a cell, such that there is a portion of the surface which has not been engraved between engraved cells. Thus a column of a desired number of cells may be engraved, followed by a non-engraved portion of the surface, after which the column of cells is continued, to a desired number of cells. There may be a plurality of non-engraved portions in any given column of cells. Suitably, a non-engraved portion is effected between every 10 to 14 engraved cells.

The length of the non-engraved portion will vary depending on the screen ruling of the surface and the image to be produced.

According to a third aspect of the present invention there is provided a gravure engraving stylus comprising a stylus holder on which is mounted a stylus body comprising a triangular prismatic or triangular prismoid-shaped tip.

Suitably the tip is a triangular prismoid-shaped tip.

Suitably at least one angled face of the triangular prismoid-shaped tip is trapezoid in shape, and preferably both angled faces are trapezoid in shape.

Preferably one or both of the faces of the triangular prism or triangular prismoid have a width of at least substantially 10 μm, more preferably at least substantially 12 μm. Preferably one or both of the faces of the triangular prism or triangular prismoid has a width of not more than 80 μm, more preferably not more than 70 μm and most preferably not more than 60 μm.

Preferably the angle of the inward taper of the angled faces to the apex of the triangular prism- or prismoid is between substantially 30° and substantially 90°, more preferably between substantially 40° and 80°. Preferably the angle of the inward taper is an angle selected from the group consisting of substantially 50°, substantially 60°, substantially 70° and substantially 90°.

Suitably the stylus body is a diamond stylus body.

Suitably the stylus holder comprises an elongate member, wherein the stylus body protrudes from one end of the stylus holder at an angle of between substantially 15° and 35° to a longitudinal axis of the elongate member, preferably between substantially 20° and 30°.

According to a fourth aspect of the present invention there is provided a gravure engraving stylus comprising a stylus holder on which is mounted a stylus body comprising a planar quadrilateral-faced tip.

Suitably the stylus body comprises an inward taper to the planar quadrilateral-faced tip.

Preferably, the face of the planar quadrilateral-faced tip is perpendicular to the longitudinal axis of the stylus body.

The planar quadrilateral-faced tip may be a rectangular-faced tip or a square-faced tip.

Preferably the tip is a square-faced tip.

Preferably the face of the square-faced tip has a width of at least substantially 10 μm, more preferably at least substantially 12 μm. Preferably the face of the square-faced tip has a width of not more than 80 μm, more preferably not more than 70 μm and most preferably not more than 60 μm.

Suitably the stylus body is a rectangular parallelopiped shaped body inwardly tapering towards the planar quadrilateral-faced tip.

Preferably the angle of the inward taper is between substantially 30° and substantially 90°, more preferably between substantially 40° and 80°. Preferably the angle of the inward taper is an angle selected from the group consisting of substantially 50°, substantially 60°, substantially 70° and substantially 80°.

Most preferably the stylus tip comprises a frustum of a quadrilateral pyramid, inwardly tapering towards a square faced tip.

Preferably the stylus body is a diamond stylus body. Suitably the stylus holder comprises an elongate member, wherein the stylus body protrudes from one end of the stylus holder at an angle of between substantially 15° and 35° to a longitudinal axis of the elongate member, preferably between substantially 20° and 30°.

According to a fifth aspect of the present invention there is provided a gravure engraving head on which is removably mounted a gravure engraving stylus of the second or third aspects of the invention.

According to a sixth aspect of the present invention there is provided a gravure engraving apparatus comprising an image scanning and processing means, operably connected to an engraving head of the fifth aspect of the invention, and an engraving surface, wherein, in use, scanned and processed information is transmitted from the image scanning and processing means to the engraving head which effects movement of the engraving head to image-wise engrave the engraving surface.

The image scanning and processing means may be separate means and may be operably connected to the engraving head by way of electrical cable, telephone lines, satellite or by use of recordable media such as magnetic disks and tapes or optical media, for example.

According to a seventh aspect of the present invention there is provided a method of the first or second aspects of the invention using a stylus of the third or fourth aspects of the invention.

### DESCRIPTION OF THE DRAWINGS

For a better understanding of the invention, and show how embodiments of the same may be put into effect, the invention will now be described by way of embodiment with reference to the following drawings, in which:

FIG. 1 is an illustration of a gravure cell pattern, engraved by a prior art gravure engraving process using an inverted triangular pyramid-shaped stylus tip;

FIG. 2A illustrates a cross-sectional side view of a gravure engraving stylus of the third aspect of the invention;

FIG. 2B shows an end view of the stylus of FIG. 2A;

FIG. 3 is an illustration of an engraved cell pattern, engraved by the method of the first aspect of the invention using a gravure engraving stylus of the FIG. 2A and 2B;

FIG. 4 is an illustration of an engraved cell pattern, engraved by the method of the second aspect of the invention using a gravure printing stylus of FIG. 2A and 2B;

FIG. 5 illustrates a side sectional view of a second embodiment of a gravure engraving stylus of the invention; and

FIG. 6 illustrates a front end view of the engraving stylus of FIG. 5.

### DESCRIPTION OF A PREFERRED EMBODIMENT

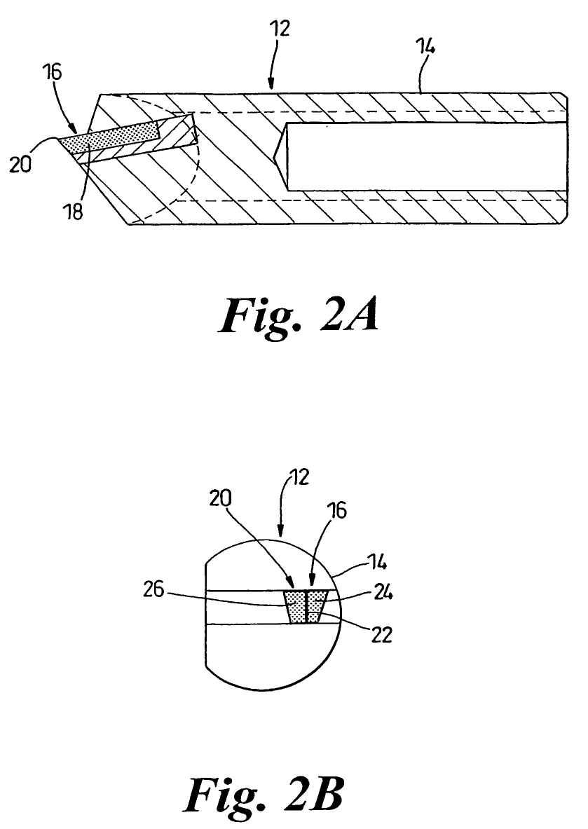

We refer firstly to FIGS. 2A and 2B, which illustrate a gravure printing stylus 16 of the third aspect of the invention. The stylus 16 comprises a stylus holder 14, which is cylindrical in shape, and in which is mounted a stylus 16 comprising a stylus body 18 which terminates at a triangular prismoid shaped tip 20. The triangular prismoid-shaped tip includes two angled faces 24 and 26, both of which are trapezoid in shape and which extend angularly to an elongate stylus apex 22.

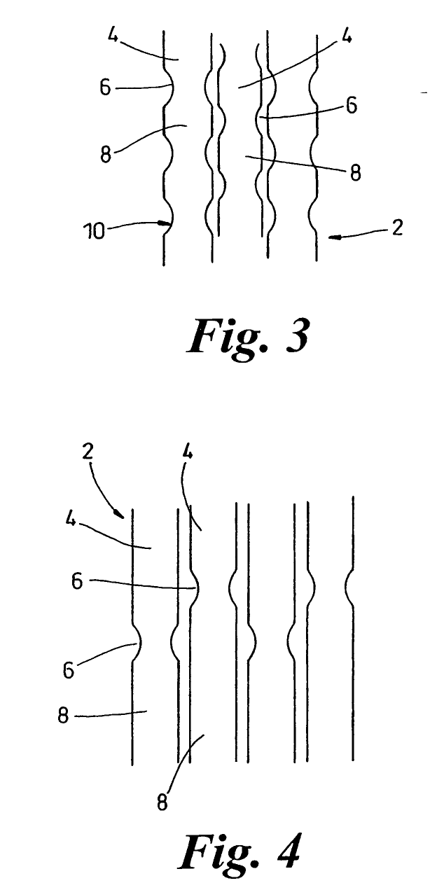

FIG. 3 shows an illustration of a partial image engraved into a copper plated gravure printing cylinder, the engraved image comprising columns of 100% cells 2 engraved using a gravure stylus 16 of the third aspect of the invention comprising a stylus holder 14 which is mounted a stylus body 18 inwardly tapering to the triangular-prismoid shaped tip 20 shown in FIGS. 2A and 2B. The stylus 16 used comprised a diamond stylus body and tip having mounted on a substantially cylindrical holder 14. The stylus body 18 was such that it protruded from one end of the stylus holder 14 at an angle of approximately 240 to the longitudinal axis of stylus body 18.

The engraving stylus was mounted in a engraving head (not shown).

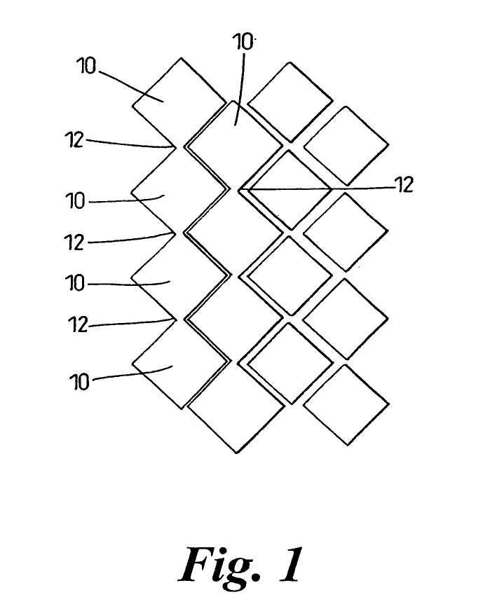

Using AC current, the tip of the engraving stylus was penetrated into the copper plated surface to a depth of 30 μm. This produced a first cell 4. Using AC current, the tip of the engraving stylus was withdrawn from the copper plated surface partially, and the copper plated surface was rotated before the engraving tip was made to penetrate further into the surface to create the second cell 8 upstream of the first cell 4. As the engraving tip was only partially withdrawn between engraving of the first cell 4 and the second cell 8, a channel 6 was produced between the two cells. The engraving tip was only withdrawn to an extent that the channel 6 has a width of approximately half that of the width of the engraved cells. Thus, the pattern of cells is such that the outer periphery 10 of the column of cells has a pseudo-continuous edge, as shown in FIG. 3, as compared to the jagged edges produced by penetration of a conventional triangular cross-section stylus tip, as shown in the illustration of a conventionally engraved image in FIG. 1.

We refer now to FIG. 4 which illustrates a partial image engraved on a copper plated engraving cylinder using the engraving stylus described for FIGS. 2A and 2B above. In this embodiment, the engraving stylus is arranged to penetrate the copper plate and using DC current, which effects continuous penetration of the stylus in the copper plate whilst the cylinder is rotated, for a desired time and rotational distance. This has the effect, as shown in FIG. 4, of producing an elongate cell having continual linear side edges. In order that the engraved cells have sufficient strength in the cell walls, the engraving stylus must be removed partially from the copper plate at prescribed distances to create a channel between cells. To produce the image shown in FIG. 4, the tip of the stylus is partially withdrawn at prescribed intervals from the copper plate for a distance of one cell. The use of a square-faced engraving stylus and DC current to maintain engraving and penetration of the stylus in the copper plate to create elongate cells, creates a substantially true linear edge to the outside periphery of an engraved image. This effect is enhanced by providing for only partial withdrawal of the engraving tip at prescribed intervals to create channels of 50% width compared to the width of engraved cells. Thus, images produced as shown in FIG. 4 will have smoother edges compared to prior art engraved images using traditional triangular cross section engraving styli which produce peripheral edges which are jagged, as shown in FIG. 1.

In order to further prevent ink flooding out of the columns of engraved cells 8, for every 10 to 14 engraved cells 8, the stylus was completely withdrawn from the surface and the surface rotated to provide a cell-free gap, after which penetration of the surface was resumed to create further cells, as described above. The cell gap produced helps to prevent ink spillage from the cells when ink is loaded into the cells. The length of the cell gap will vary depending on conditions such as cell depth, image to be created, cell width, and screen ruling of the surface.

For the pattern produced in FIG. 3, the following parameters of the engraving stylus shown in FIGS. 2A and 2B, the surface, the engraving screen and the method were employed:

Engraving screen:

| 35-160 lines per centimetre | |
|---|---|
| Angle of stylus tip to surface | 20°-60° |
| Stylus taper to stylus tip | 50°-70° |
| Stylus bottom | 20-100 μm flat |
| Cell width | 50-280 μm |
| Vertical cell/pixel spacing | variable |

In further embodiments of the invention the gravure engraving stylus may comprise a triangular prismatic or triangular prismoidal shaped tip or a planar-quadrilateral faced tip (especially a square-faced tip). A particularly useful embodiment provides a gravure engraving stylus comprising a stylus tip comprising a frustum of a quadrilateral pyramid, inwardly tapering to a square-faced tip.

In embodiments wherein the gravure engraving stylus comprises a triangular prismoid-shaped tip, or triangular prismatic shaped tip, suitably both angled faces of the tip have a width of substantially 10 μm, preferably at least substantially 12 μm, and preferably one or both of the faces have a width of not more than 80 μm, and preferably not more than 70 μm and most preferably not more than 60 μm. Suitably the angle of the inward taper of the angled faces to the apex of the triangular prism or prismoid is between substantially 30° and substantially 90°. In preferred embodiments the stylus holder comprises an elongate member and wherein the stylus body protrudes from one end of the stylus holder at an angle of between substantially 15° and 35° to a longitudinal axis of the elongate member.

Embodiments in which a planar quadrilateral faced tip is employed in the gravure engraving stylus, suitably the tip is a square faced tip, having a width of at least substantially 10 μm and more preferably at least substantially 12 μm, and also preferably having a width of no more than 80 μm and preferably no more than 70 μm. Suitably the angle of the inward taper of the square or quadrilateral face tip is between substantially 30° and substantially 90°.

In all embodiments, a preferred material for the stylus body and stylus tip is diamond.

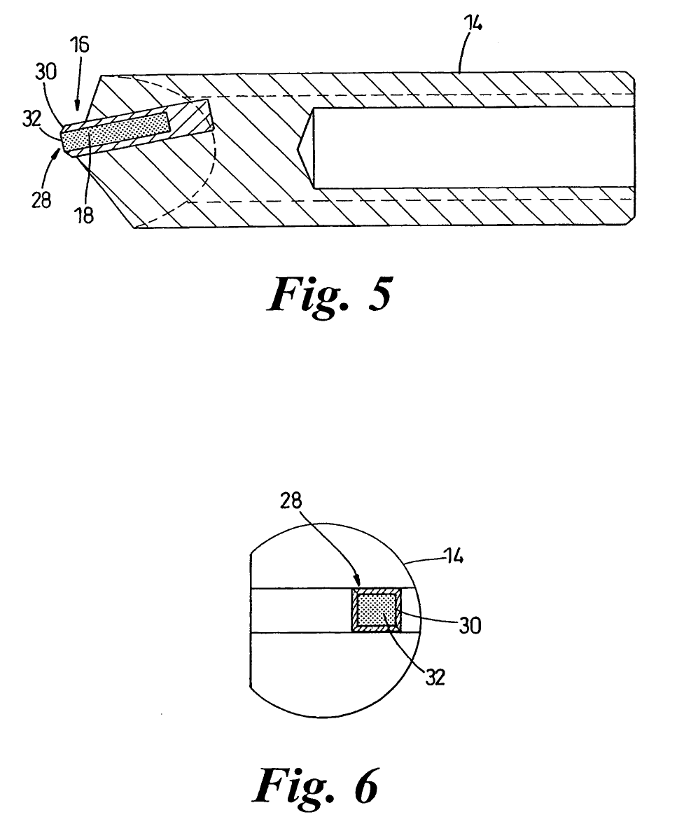

We refer now to FIGS. 5 and 6. FIGS. 5 and 6 illustrate an embodiment of the gravure engraving stylus of the fourth aspect of the invention. The gravure stylus 16 is similar to the gravure stylus 16 of FIGS. 2A & 2B, and like numerals represent like components. The stylus 16 of FIGS. 5 and 6 comprises a planar quadrilateral-faced tip 28 comprising an inwardly tapering section 30 which terminates at a planar square-faced apex 32, the face of the apex 32 being perpendicular to the longitudinal direction of the stylus body 18. Thus, the tip 28 takes the form of a frustum of a quadrilateral pyramid, inwardly tapering to the square-face 28. Use of the gravure engraving stylus of FIG. 5 & 6 is substantially identical to use of the stylus of FIGS. 2A & 2B, as described hereinabove.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments(s). The invention extend to any novel one, or any novel combination, of the features disclosed in this specification (including any accompanying claims, abstract and drawings), or to any novel one, or any novel combination, of the steps of any method or process so disclosed.

1. A method of engraving a plurality of gravure cells in a surface, the method comprising the steps of:
(a) mounting an engraving stylus comprising a stylus body inwardly tapering to the stylus tip, in an engraving head;
(b) effecting penetration of the engraving stylus into the surface to a desired depth to produce a cell;
(c) effecting partial withdrawal of the engraving stylus from the cell;
(d) effecting relative movement between the stylus and the surface such that the partially withdrawn stylus effects engraving of a channel of shallower depth than the cell in the surface and having a channel width of at least 40% of the width of the previous cell engraved in the method; and
(e) effecting further penetration of the engraving stylus into the surface to a desired depth, and effecting relative movement between the stylus and surface to produce a cell.

2. A method as claimed in claim 1, further comprising repeating steps (c) to (e) at least one more time.

3. A method as claimed in claim 1, wherein step (c) comprises withdrawing the stylus from the cell such that the channel formed during step (d) has a width of substantially 45-65% of that of the previously engraved cell,

4. A method as claimed in claim 1, wherein the depth of penetration of the stylus during step (e) is different to the depth of penetration in step (b)

5. A method as claimed in Claim 1, wherein the penetration of the stylus is effected to produce cells having a width of between substantially 50 μm to 80 μm.

6. A method as claimed in claim 1, wherein penetration of the stylus is effected to produce cells having a depth of between substantially 20 μm to 35 μm.

7. A method of engraving a gravure cell in a surface, the method comprising the steps of:
(a) mounting an engraving stylus in an engraving head;
(b) effecting penetration of the engraving stylus into the surface to a desired depth to produce a cell;
(c) passing direct current through the engraving head to effect continual penetration of the engraving stylus in the surface; and
(d) effecting relevant movement between the stylus and the surface such that the continued penetration of the stylus effects elongation of the engraved cell.

8. A method as claimed in claim 7, wherein the stylus comprises a stylus body which tapers inwardly to the stylus tip and the method further comprises the steps of:
(e) effecting partial withdrawal of the engraving stylus from the cell;
(f) effecting relative movement between the stylus and the surface such that the partially withdrawn stylus effects engraving of a channel of shallower depth then the previous cell in the surface; and
(g) effecting further penetration of the engraving stylus into the surface to a desired depth, passing direct current through the engraving head and effecting further relative movement between the stylus and surface to produce a cell.

9. A method as claimed in claim 8, wherein the method further comprises repeating steps (c) to (g) at least one more time

10. A method as claimed in claim 8, wherein the depth of penetration of the stylus during step (g) is different to the depth of penetration in step (b).

11. A method as claimed in claim 7, wherein penetration of the stylus is effected to produce cells having a width of between substantially 50 μm to 80 μm.

12. A method as claimed in claim 7, wherein penetration of the stylus is effected to produce cells having a depth of between substantially 30 μm to 100 μm.

13. A method as claimed in claim 7, further comprising effecting complete withdrawal of the engraving head from the surface after a desired number of cells have been engraved, and subsequently effecting relative movement between the stylus and the surface, before effecting further penetration of the engraving stylus into the surface to a desired depth to produce a cell, such that there is a portion of the surface which has not been engraved between engraved cells.

14. A method as claimed in claim 13, wherein there are a plurality of non-engraved portions in any given column of cells.

15. A method as claimed in claim 14, wherein a non-engraved portion is effected between every 10 to 14 engraved cells.

16. A gravure engraving stylus comprising a stylus holder on which is mounted a stylus body comprising a triangular prismatic or triangular prismoid-shaped tip.

17. A gravure engraving stylus as claimed in claim 16, wherein the tip is a triangular prismoid-shaped tip.

18. A gravure engraving stylus as claimed in claim 17, wherein at least one angled face of the triangular prismoid-shaped tip is trapezoid in shape.

19. A gravure engraving stylus as claimed in claim 17, wherein both angled faces of the triangular prismoid-shaped tip are trapezoid in shape.

20. A gravure engraving stylus as claimed in claim 16, wherein one or both faces of the triangular prism or triangular prismoid have the width of at least 10 μm.

21. A gravure engraving stylus as claimed in claim 16, wherein one or both faces of the triangular prism or triangular prismoid have a width of not more than 80 μm.

22. A gravure engraving stylus as claimed in claim 16, wherein the angle of the inward taper of the angle faces to the apex of the triangular prism or prismoid is between substantially 40° and substantially 90°.

23. A gravure engraving stylus as claimed in claim 16, wherein the stylus is a diamond stylus.

24. A gravure engraving stylus as claimed in claim 16, wherein the stylus holder comprises an elongate member, wherein the stylus body protrudes from one end of the stylus holder at an angle of between substantially 15° and 35° to a longitudinal axis of the elongate member.

25. A gravure engraving stylus comprising a stylus holder on which is mounted a stylus body comprising a planar quadrilateral-faced tip.

26. A gravure engraving stylus as claimed in claim 25, wherein the stylus body comprises an inward taper to the planar quadrilateral-faced tip.

27. A gravure engraving stylus as claimed in claim 25, wherein the face of the planar quadrilateral-faced tip is perpendicular to the longitudinal axis of the stylus body.

28. A gravure engraving stylus as claimed in claim 25, wherein the planar quadrilateral-faced tip is a rectangular-faced tip or a square-faced tip.

29. A gravure engraving stylus as claimed in claim 28, wherein the quadrilateral-faced tip having a width of at least substantially 10 μm.

30. A gravure engraving stylus as claimed in claim 25, wherein the square-faced tip has a width of not more than 80 μm.

31. A gravure engraving stylus as claimed in claim 25, wherein the stylus body is a rectangular parallelopiped shaped body inwardly tapering towards the planar quadrilateral-faced tip.

32. A gravure engraving stylus as claimed in claim 31, wherein the angle of the inward taper is between substantially 40° and substantially 90°.

33. A gravure engraving stylus as claimed in claim 16, wherein the stylus tip comprises a frustum of a quadrilateral pyramid, inwardly tapering towards a square faced tip.

34. A gravure engraving stylus as claimed in claim 25, wherein the stylus body is a diamond stylus body.

35. A gravure engraving stylus as claimed in claim 25, wherein the stylus holder comprises an elongate member, and the stylus body protrudes from one end of the stylus holder at an angle of between substantially 15° and substantially 35° to a longitudinal axis of the elongate member.

36. A gravure engraving head on which is removably mounted a gravure engraving stylus of claim 16.

37. A gravure engraving apparatus comprising an image scanning and processing means, operably connected to an engraving head as claimed in claim 36, and an engraving surface, wherein in use, scanned and processed information is transmitted from the imaged scanning and processing means to the engraving head which effects movement of the engraving head to image-wise engrave the engraving surface.

38. A gravure engraving apparatus as claimed in claim 37, wherein the image scanning and processing means are separate means.

39. A method as claimed in Claim any one of claims 1, wherein the engraving stylus is a gravure engraving stylus comprising a stylus holder on which is mounted a stylus body comprising a triangular prismatic or triangular prismoid-shaped tip.

40-43. (canceled)

44. A method as claimed in claim 1, wherein step (c) comprises withdrawing the stylus from the cell such that the channel formed during step (d) has a width of substantially 50% of that of the previously engraved cell.

45. A method as claimed in claim 8, wherein the method further comprises repeating steps (c) to (g) a plurality of times.

46. A gravure engraving head on which is removably mounted a gravure engraving stylus of claim 25.

47. A gravure engraving stylus as claimed in claim 25, wherein the stylus tip comprises a frustum of a quadrilateral pyramid, inwardly tapering towards a square faced tip.

48. A method as claimed in claim 1, wherein the engraving stylus is a gravure engraving stylus comprising a stylus holder on which is mounted a stylus body comprising a planar quadrilateral-faced tip.
